(19) United States
(12) Patent Application Publication
(10) Pub. No.: US 2006/0124461 A1
(43) Pub. Date: Jun. 15, 2006

(54) Method of coating electric wire having edges and insulated wire

(76) Inventors: Toshitaka Kawanami, Osaka (JP); Hiroyuki Sakamoto, Osaka (JP); Hidenori Tanaka, Osaka (JP); Kazuo Morichika, Osaka (JP); Takao Saito, Osaka (JP)

Correspondence Address: JORDAN AND HAMBURG LLP, 122 EAST 42ND STREET, SUITE 4000, NEW YORK, NY, 10168, US

(21) Appl. No.: 10/555,567

(22) PCT Filed: May 12, 2004
(86) PCT No.: PCT/JP04/06683

§ 371 Date: Feb. 2, 2006

(30) Foreign Application Priority Data
May 12, 2003 (JP) 2003-133713

(51) Int. Cl. C25B 7/00; C09D 5/44

(52) U.S. Cl. 204/502; 204/471

(57) ABSTRACT

It is an object of the present invention to provide a method of coating an electric wire having edges, by which insulated wires having a high dielectric breakdown voltage can be attained. A method of coating an electric wire having edges, comprising a step of: forming an insul at ing film by cationic electrodeposition using a cationic electrocoating, the cationic electrocoating containing a resin composition of which a hydratable functional group is reduced directly by electrons and passivated, resulting in deposition of a film, and the cationic electrocoating containing crosslinked resin particles.

### TECHNICAL FIELD

The present invention relates to a method of coating an electric wire having edges, and an insulated wire.

### BACKGROUND ART

Insulated wires have been in wide use in the application areas such as electric and electronic equipment. These insulated wires generally have a structure in that an insulating film for protection and insulation is formed on a conductive wire and, it has been also implemented to produce the insulated wire by electrodeposition using an electrocoating being conventionally in widespread use (see, for example, Japanese Kokai Publication Sho-48-49826 and Japanese Kokai Publication Hei-3-159014).

However, when an article to be coated has edges such as a shaped wire, the film thickness of an insulating film formed at an edge becomes thin; consequently, an insulated wire having an adequate insulating property may not be attained.

Therefore, the development of a method of coating has been desired, by which an insulating film can be formed on an article to be coated having edges, such as a shaped wire, in a sufficient film thickness even at edges and an insulated wire having a high insulating property can be attained.

### SUMMARY OF THE INVENTION

In view of the above-mentioned circumstances, it is an object of the present invention to provide a method of coating an electric wire having edges, by which insulated wires having a high dielectric breakdown voltage can be attained.

The present invention is directed to a method of coating an electric wire having edges, comprising a step of:
forming an insulating film by cationic electrodeposition using a cationic electrocoating,
the cationic electrocoating containing a resin composition of which a hydratable functional group is reduced directly by electrons and passivated, resulting in deposition of a film, and
the cationic electrocoating containing crosslinked resin particles.

Preferably, the crosslinked resin particle is one of which a hydratable functional group is reduced directly by electrons and passivated.

Preferably, the content of the crosslinked resin particles is 0.5 to 40% by weight.

Preferably, the crosslinked resin particle is obtained by emulsion polymerizing an α,β-ethylenically unsaturated monomer mixture using a resin having an onium group as an emulsifier.

Preferably, the resin having an onium group has 2 to 15 onium groups per one molecule.

Preferably, the resin having an onium group is an acrylic resin or an epoxy resin.

Preferably, the onium group is an ammonium group or a sulfonium group.

Preferably, the acrylic resin or the epoxy resin, having the ammonium group or the sulfonium group, is obtained by adding a tertiary amine compound or sulfide and an organic acid to an acrylic resin or an epoxy resin, having an epoxy group, to convert the acrylic resin or the epoxy resin to a quaternary ammonium compound or a tertiary sulfonium compound.

Preferably, a number-average molecular weight of the acrylic resin or the epoxy resin, having an epoxy group, is 2000 to 20000.

Preferably, the resin composition has a sulfonium group and a propargyl group.

Preferably, the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

Preferably, the resin composition includes an epoxy resin having a novolak cresol epoxy resin or a novolak phenol epoxy resin as a skeleton and having a number-average molecular weight of 700 to 5000, and
the resin composition also has a sulfonium group content of 5 to 250 milli moles, a propargyl group content of 20 to 395 milli moles and a total content of the sulfonium and propargyl groups of 400 milli moles or less, per 100 g of the solid matter in the resin composition.

The present invention is also directed to an insulated wire obtained by the above-mentioned method of coating an electric wire having edges.

### BRIEF DESCRIPTION OF THE DRAWINGS

FIG. 1 shows an example of a schematic view of a cross section of an insulated wire obtained by the method of coating an electric wire having edges in accordance with the present invention; and

FIG. 2 shows an example of a schematic view of a cross section of an insulated wire obtained in the case of using no crosslinked resin particle.

### EXPLANATION OF THE NUMERICAL SYMBOLS

1 shaped wire

2 insulating film

3 insulated wire

4 edge

5 insulated wire

### DETAILED DESCRIPTION OF THE INVENTION

Hereinafter, the present invention will be described in detail.

Since the method of coating an electric wire having edges of the present invention comprises the step described above, it is a method by which an insulated wire having a higher dielectric breakdown voltage than an insulated wire prepared from only a conventional electrocoating can be attained.

In the method of coating an electric wire having edges of the present invention, a cationic electrocoating contains crosslinked resin particles. Since the cationic electrocoating contains the crosslinked resin particles, an insulating film can be formed in a sufficient film thickness even at edges of an article to be coated, and an insulated wire having a high dielectric breakdown voltage can be attained.

The crosslinked resin particle has the function of providing a thixotropic property in the cationic electrocoating. Thus, in baking and curing the applied film to form an insulating film, an insulating film can be formed in a sufficient film thickness even at edges of an article to be coated and, as a result, an insulated wire having a high dielectric breakdown voltage can be attained.

For example, when an article to be coated is electrodeposited using the cationic electrocoating containing the crosslinked resin particles, the function of the crosslinked resin particle to provide a thixotropic property allows the whole surface of the article to be coated, that is, the whole surface including the edges to be coated with a sufficient insulating film and an insulated wire to be obtained to be provided with a high dielectric breakdown voltage.

When the cationic electrocoating does not contain the crosslinked resin particles or contains non-crosslinked resin particles, an insulated wire having a high dielectric breakdown voltage may not be obtained since edges cannot be coated in a sufficient film thickness.

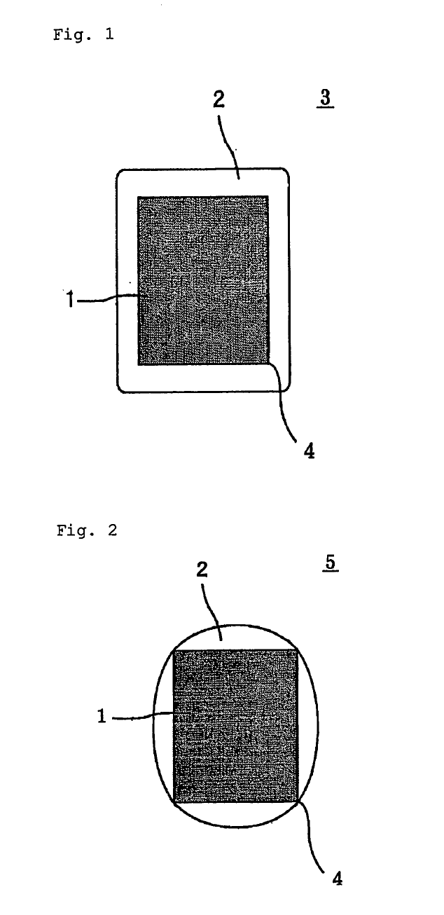

FIG. 1 shows an example of a conceptual view of the insulated wire obtained by electrodeposition using the cationic electrocoating containing the crosslinked resin particles in the method of coating an electric wire having edges in accordance with the present invention. FIG. 1 shows an insulated wire 3 which is obtained by forming an insulating film 2, to be formed by electrodeposition using the cationic electrocoating, on a shaped wire 1. The insulated wire 3, obtained in the case where the cationic electrocoating containing the crosslinked resin particles is used, is provided with the insulating film 2 with a sufficient film thickness even on edges 4 of the shaped wire 1. Accordingly, the insulated wire 3 obtained by the above coating method has a high dielectric breakdown voltage.

On the other hand, FIG. 2 shows an example of a conceptual view of the insulated wire obtained by forming an insulating film using a cationic electrocoating containing no crosslinked resin particles. The insulated wire 5, obtained in the case where a cationic electrocoating containing no crosslinked resin particles is used, is not provided with the insulating film 2 with a sufficient film thickness on the edges 4 of the shaped wire 1. Consequently, the insulated wire 5 obtained by the above coating method has a lower dielectric breakdown voltage in comparison to the insulated wire obtained by the method of coating an electric wire having edges in accordance with the present invention.

The crosslinked resin particle is not particularly limited, but includes a compound obtained by a so-called emulsion method in which a polymerizable monomer is crosslinked in an aqueous medium while being emulsion polymerized in the presence of a resin having a emulsifying power and an initiator, and a compound obtained by a so-called NAD method in which a polymerizable monomer is crosslinked while being copolymerized in a mixed solution of an organic solvent and a dispersion-stable resin soluble in an organic solvent, which are methods well known to those skilled in the art. Here, when the crosslinked resin is obtained by the NAD method, a substance including the polymerizable monomer crosslinked through copolymerization and the dispersion-stable resin is referred to as a crosslinked resin particle.

As a volume-average particle diameter of the crosslinked resin particles, it is preferred that specifically, a lower limit is 0.05 μm and an upper limit is 1 μm. When it is less than 0.05 μm, the thickness of film at the edges may become insufficient, and when it exceeds 1 μm, an appearance of the insulating film may be deteriorated. More preferably, the lower limit is 0.07 μm and the upper limit is 0.5 μm. This volume-average particle diameter can be controlled by adjusting, for example, the composition or the polymerization conditions of a polymerizable monomer. The volume-average particle diameter can be determined, for example, by a laser-light-scattering method and the like.

The crosslinked resin particle is preferably one of which a hydratable functional group is reduced directly by electrons and passivated. It is possible to provide a good thixotropic property for a filming by using such crosslinked resin particles. Thereby, an insulating film can be sufficiently formed even at edges of an article to be coated, and an insulated wire having a high dielectric breakdown voltage can be attained.

In the present invention, the mechanism of deposition of the crosslinked resin particle on the cathode as caused by voltage application is represented by the following formula (1). The crosslinked resin particle is passivated to be deposited by providing the hydratable functional group in the crosslinked resin particle (substrate; expressed by “S” in the formula) with electrons on the cathode.

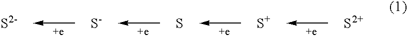

That is, when the reaction represented by the above formula (1) occurs, the hydratable functional group existing in the crosslinked resin particle in the cationic electrocoating is directly reduced on the cathode, resulting in insolubilization and deposition of the crosslinked resin particle. The film deposited according to this mechanism has a high dielectric breakdown voltage.

In particular, the crosslinked resin particle is preferably obtained by emulsion polymerizing an α,β-ethylenically unsaturated monomer mixture using a resin having an onium group as an emulsifier. By containing such a crosslinked resin particle, it is possible to coat edges sufficiently with an insulating film and to obtain an insulated wire having a higher dielectric breakdown voltage.

The above-mentioned α,β-ethylenically unsaturated monomer mixture generally contains poly(meth)acrylate having two or more α,β-ethylenically unsaturated bonds in a molecule in order to crosslink the resin particle. The content of the poly(meth)acrylate having two or more α,β-ethylenically unsaturated bonds in a molecule is preferably 5% by weight (lower limit) to 15% by weight (upper limit) relative to 100% by weight of total solid matter in the α,β-ethylenically unsaturated monomer mixture. When this content is less than 5% by weight, crosslinking of the resin particle does not adequately proceed, and when it exceeds 15% by weight, crosslinking of the resin particle proceeds excessively; therefore, physical properties of an insulating film to be obtained may be deteriorated.

As the above-mentioned poly(meth)acrylate having two or more α,β-ethylenically unsaturated bonds in a molecule, there may be given, for example, a compound having a structure in which a plurality of (meth)acrylic acids combine with dihydric or higher alcohol in the form of an ester linkage, and the like. Examples of the above-mentioned compound having a structure in which a plurality of (meth)acrylic acids combine with dihydric or higher alcohol in the form of an ester linkage may include ethylene glycol di(meth)acrylate, triethylene glycol di(meth)acrylate, neopentyl glycol di(meth)acrylate, tetraethylene glycol di(meth)acrylate, trimethylol propane tri(meth)acrylate, and the like. These compounds may be used alone or in combination of two or more kinds of them.

The α,β-ethylenically unsaturated monomer mixture contains a general α,β-ethylenically unsaturated monomer besides the above-mentioned poly(meth)acrylate. As the above-mentioned general α,β-ethylenically unsaturated monomer, there may be given a compound having a reactive functional group and a compound having no reactive functional group.

Examples of the α,β-ethylenically unsaturated monomer having the reactive functional group may include hydroxyethyl (meth)acrylate, hydroxypropyl (meth)acrylate, hydroxybutyl (meth)acrylate, allyl alcohol, methacrylic alcohol, hydroxyl group-containing compounds such as ε-caprolactam adduct of hydroxyethyl (meth)acrylate; epoxy group-containing compounds such as glycidyl (meth)acrylate, and the like.

When the α,β-ethylenically unsaturated monomer having the reactive functional group is contained in the above-mentioned α,β-ethylenically unsaturated monomer mixture, the content of the α,β-ethylenically unsaturated monomer having the reactive functional group is preferably 20% by weight or less relative to 100% by weight of the above-mentioned α,β-ethylenically unsaturated monomer mixture. When the content exceeds 20% by weight, the water resistance of a film to be obtained may be deteriorated. Both of the hydroxyl group value or epoxy value of the above-mentioned α,β-ethylenically unsaturated monomer mixture in this case is preferably 20 or less. When it exceeds 20, the water resistance or the insulating property of a film to be obtained may be deteriorated.

On the other hand, examples of the α,β-ethylenically unsaturated monomer having no reactive functional group may include (meth)acrylic ester such as methyl (meth)acrylate, ethyl (meth)acrylate, n-propyl (meth)acrylate, iso-propyl (meth)acrylate, n-butyl (meth)acrylate, isobutyl (meth)acrylate, t-butyl (meth)acrylate, 2-ethylhexyl (meth)acrylate, lauryl (meth)acrylate, isobornyl (meth)acrylate, cyclohexyl (meth)acrylate, t-butylcyclohexyl (meth)acrylate, dicyclopentadienyl (meth)acrylate, and dihydrodicyclopentadienyl (meth)acrylate; polymerizable amide compounds such as (meth)acrylamide, N-methylol (meth)acrylamide, N-butoxymethyl(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, N-(2-hydroxyethyl)acrylamide, and N-(2-hydroxyethyl)methacrylamide; polymerizable aromatic compounds such as styrene, α-methylstyrene, vinyl ketone, t-butylstyrene, p-chlorostyrene, and vinyl naphthalene; polymerizable nitriles such as acrylonitrile, and methacrylonitrile; ethylene, propylene and the like; vinyl esters (e.g., α-olefins such as vinyl acetate and vinyl propionate); diens such as butadiene and isoprene.

In the resin having an onium group used as an emulsifier in emulsion polymerization for preparing the crosslinked resin particle, the number of onium groups is preferably 2 to 15 per one molecule. When the number of onium groups is less than 2 per one molecule, the stability of dispersion may be deteriorated, and when it exceeds 15, the water resistance of an insulating film to be obtained may be deteriorated. In addition, as the onium group, there may be given an ammonium group or a sulfonium group, but the ammonium group is preferable from the viewpoint of water resistance.

Examples of the resin having the ammonium group or sulfonium group may include an acrylic resin, a polyester resin, an epoxy resin, a urethane resin and the like. An acrylic resin or an epoxy resin is preferable from the viewpoint of design. The above-mentioned acrylic resin or epoxy resin can be attained by various methods but it can be easily obtained by adding a tertiary amine compound or sulfide and an organic acid to an acrylic resin or an epoxy resin, having an epoxy group, to convert the acrylic resin or the epoxy resin to a quaternary ammonium compound or a tertiary sulfonium compound. In addition, this conversion to a quaternary ammonium compound or a tertiary sulfonium compound may be carried out by previously preparing a mixture of a tertiary amine compound and an organic acid or sulfide and an organic acid and adding this mixture to the acrylic resin or the epoxy resin, having an epoxy group, as an ammonium quaternizing agent or a sulfonium tertiarizing agent.

An acrylic resin having an epoxy group, which is used for conversion to a quaternary ammonium compound or a tertiary sulfonium compound, can be obtained by polymerizing a mixed monomer solution comprising an α,β-ethylenically unsaturated monomer having an epoxy group such as glycidyl (meth)acrylate and another α,β-ethylenically unsaturated monomer according to an ordinary technique. In this method of conversion to a quaternary ammonium compound or a tertiary sulfonium compound, the amount of the α,β-ethylenically unsaturated monomer having an epoxy group may be determined depending on the number of onium groups described above because an epoxy group is converted to an onium group by being ring-opened with a tertiary amine compound or sulfide. The above-mentioned another α,β-ethylenically unsaturated monomer refers to the above-mentioned general α,β-ethylenically unsaturated monomer, for example, in the α,β-ethylenically unsaturated monomer mixture described above.

As the above-mentioned epoxy resin, there are suitably used those having at least two epoxy groups in one molecule, including, for example, polyepoxy resins such as epi-bis-epoxy resins; modifications thereof obtained by extending its chain with diol, dicarboxylic acid or diamine; epoxidized polybutadiene; novolak phenol polyepoxy resins; novolak cresol polyepoxy resins; polyglycidyl acrylate; polyglycidyl ethers of aliphatic polyols or polyethers polyol; and polyglycidyl esters of polybasic carboxylic acids. In particular, novolak phenol polyepoxy resins, novolak cresol polyepoxy resins and polyglycidyl acrylate are preferable because of the ease of polyfunctionalization for enhancing curability. In addition, part of the above-mentioned epoxy resin may be a monoepoxy resin.

A number-average molecular weight of the above-mentioned acrylic resin or epoxy resin, having an epoxy group, is preferably 2000 to 20000. When the number-average molecular weight is less than 2000, the thickness of film at the edges may be insufficient, and when it exceeds 20000, a rise in viscosity of an emulsifier may become a problem.

The tertiary amine compound for introducing above-mentioned ammonium group in an acrylic resin or an epoxy resin is not particularly limited, but includes trimethylamine, triethylamine, tributylamine, trioctylamine, dimethylethanolamine, methyldiethanolamine, and the like. Incidentally, the amount of the tertiary amine compound may be determined in conformity with the amount of ammonium group to be introduced.

The sulfide for introducing above-mentioned sulfonium group in an acrylic resin or an epoxy resin is not particularly limited, and examples thereof may include aliphatic sulfides, aliphatic-aromatic mixed sulfides, aralkyl sulfides, and cyclic sulfides. Specific examples thereof may include diethyl sulfide, dipropyl sulfide, dibutyl sulfide, dihexyl sulfide, diphenyl sulfide, ethyl phenyl sulfide, tetramethylene sulfide, pentamethylene sulfide, thiodiethanol, thiodipropanol, thiodibutanol, 1-(2-hydroxyethylthio)-2-propanol, 1-(2-hydroxyethylthio)-2-butanol, and 1-(2-hydroxyethylthio)-3-butoxy-1-propanol.

An organic acid used for conversion to a quaternary ammonium compound or a tertiary sulfonium compound is not particularly limited, and examples thereof may include formic acid, acetic acid, lactic acid, propionic acid, boric acid, butyric acid, dimethylolpropionic acid, hydrochloric acid, sulfuric acid, phosphoric acid, N-acetylglycine, and N-acetyl-β-alanine. In particular, lactic acid, acetic acid and dimethylolpropionic acid are preferable in point of the stability in emulsifying.

In this conversion to a quaternary ammonium compound or a tertiary sulfonium compound, the molar ratio among an epoxy group, a tertiary amine compound or sulfide, and an organic acid in an acrylic resin or an epoxy resin having an epoxy group is preferably 1:1:1 to 1:1:2. A reaction of conversion to a quaternary ammonium compound or a tertiary sulfonium compound is generally conducted over 2 to 10 hours and may be heated to 60 to 100° C. as required.

The crosslinked resin particle, contained in a cationic electrocoating composition, in the present invention can be obtained by conducting emulsion polymerization using a resin having an onium group obtained in such a manner as described above as an emulsifier. The emulsion polymerization can be conducted using a method being usually well known. For example, this can be conducted by dissolving an emulsifier in an aqueous medium including water, or an organic solvent such as alcohol or the like as required and adding the above-mentioned α,β-ethylenically unsaturated monomer mixture and an initiator dropwise to this solution under being heated and stirred. An α,β-ethylenically unsaturated monomer mixture previously emulsified with an emulsifier and water may be added dropwise similarly.

The above-mentioned emulsion polymerization is preferably conducted following a procedure in which an emulsifier is dissolved in an aqueous medium and after an initiator is added dropwise to this solution under being heated and stirred, part of the α,β-ethylenically unsaturated monomer is added dropwise and, then, the rest of α,β-ethylenically unsaturated monomer mixture, which has been previously emulsified with an emulsifier and water, is added dropwise. By emulsion polymerizing using this procedure, the deviation from a desired particle diameter is reduced and preferable crosslinked resin particles can be obtained.

The initiator is not particularly limited, and preferable examples thereof may include oily azo compounds (e.g., azobisisobutyronitrile, 2,2′-azobis(2-methylbutyronitrile), 2,2′-azobis(2-(2-imidazoline-2-yl)propane), 2,2′-azobis (2,4-dimethylvaleronitrile) and the like); aqueous compounds (e.g., 4,4′-azobis(4-cyanovalerate), 2,2′-azobis(N-(2-carboxyethyl)-2-methylpropionamidine) of anionic compounds, and 2,2′-azobis (2-methylpropionamidine) of cationic compounds; oily redox peroxides (e.g., benzoyl peroxide, p-chlorobenzoyl peroxide, lauroyl peroxide, t-butyl perbenzoate, and the like); and aqueous peroxides (e.g., potassium persulfate, ammonium persulfate, and the like)

The resin having an onium group, described above, is used as the emulsifier. Further, it is possible to use compounds usually used by those skilled in the art or reactive emulsifiers, e.g., ANTOXMS-60 (made by Nippon Surfactant Co., Ltd.), ELEMINOL JS-2 (made by Sanyo Kasei Co., Ltd.), ADEKARIA SOAP NE-20 (made by Asahi Denka Co., Ltd.), and AQUARON HS-10 (made by Daiichi Kogyo Seiyaku Co., Ltd.), in combination with the resin having an onium group. Here, the above-mentioned reactive emulsifier is assumed to be not included in an α,β-ethylenically unsaturated monomer contained in the monomer mixture described above.

The ratio by weight between the above-mentioned resin having an onium group and the above-mentioned α,β-ethylenically unsaturated monomer mixture (weight of the resin having an onium group/weight of the α,β-ethylenically unsaturated monomer mixture) is preferably 5:95 to 50:50. When the above-mentioned ratio by weight is out of the above range, the appearance of an insulating film may be deteriorated.

In the above emulsion polymerization, mercaptan such as lauryl mercaptan and a chain transfer agent such as α-methylstyrene dimer may be used as required in order to adjust a molecular weight.

A reaction temperature in the above emulsion polymerization depends on an initiator, and for example, it is preferably 60 to 90° C. in azo initiators and 30 to 70° C. in redox initiators. Generally, a reaction time is 1 to 8 hours. The ratio of the initiator to the total amount of the α,β-ethylenically unsaturated monomer mixture is generally 0.1% by weight (lower limit) to 5% by weight (upper limit). Preferably, the above lower limit is 0.2% by weight and the above upper limit is 2% by weight.

The cationic electrocoating in the present invention preferably contains the crosslinked resin particle obtained in a manner described above in an amount of 0.5 to 40% by weight relative to the resin solid matter in the coating composition. When the above-mentioned content of the crosslinked resin particle is less than 0.5% by weight, the thickness of film at the edges may become insufficient, and when it exceeds 40% by weight, an appearance of the insulating film may be deteriorated. The above content is more preferably 1 to 30% by weight.

The method of coating an electric wire having edges in accordance with the present invention comprises the step of forming an insulating film by cationic electrodeposition using a cationic electrocoating. Since the cationic electrocoating used in the present invention contains the above-mentioned crosslinked resin particles, an insulated wire having a higher dielectric breakdown voltage than an insulated wire prepared from a conventional cationic electrocoating can be attained.

The cationic electrocoating used in the present invention contains a resin composition of which a hydratable functional group is reduced directly by electrons and passivated, resulting in deposition of a film. The mechanism of deposition on the cathode as caused by voltage application is represented by the above-mentioned formula (1); thereby, a film is deposited.

Preferably, the resin composition has a sulfonium group and a propargyl group. By using the resin composition having a sulfonium group and a propargyl group, insulated wires having a higher dielectric breakdown voltage can be attained.

The resins composing the above resin composition may contain both a sulfonium group and a propargyl group in each molecule, but it does not necessarily do so. Thus, for example, the resins may have only either the sulfonium group or the propargyl group in each molecule. In the latter case, however, the whole resin composition have both of these two kinds of curable functional groups. That is, the above resin composition may comprise any resin containing sulfonium group and propargyl group, a mixture of a resin having only a sulfonium group(s) and a resin having only a propargyl group(s), or a mixture of all of these kinds of resins. It is herein defined in the above sense that the resin composition has both sulfonium and propargyl groups.

The sulfonium group is a hydratable functional group in the resin composition. When an electric voltage or current exceeding a certain level is applied to the sulfonium group in the electrodeposition step, the group is subjected to an electrolytic reduction on the electrode; thereby, the ionic group disappears and the sulfonium group can be irreversibly passivated.

It is considered that, in this electrodeposition step, the electrode reaction provoked generates the hydroxide ion, and the sulfonium group holds the hydroxide ion, with the result that an electrolytically generated base is formed in the electrodeposited film. This electrolytically generated base can convert the propargyl group existing in the electrodeposited coat and being low in reactivity upon heating to the allene bond high in reactivity upon heating.

A resin forming the skeleton of the resin composition is not particularly limited, but an epoxy resin is favorably used. As the above-mentioned epoxy resin, there may, for example, the epoxy resin described previously.

Preferably, the resin composition includes a resin having the epoxy resin as a skeleton and has a number-average molecular weight of 500 (lower limit) to 20000 (upper limit). When it is less than 500, the coating efficiency in the electrodeposition step will be poor, and when it exceeds 20000, a good film cannot be formed on the surface of a substrate. As for the number-average molecular weight, a more preferable molecular weight can be selected in accordance with the resin skeleton. In the case of novolak phenol epoxy resins and novolak cresol epoxy resins, for example, the lower limit is preferably 700 and the upper limit is preferably 5000.

Preferably, the sulfonium group content in the resin composition is within a range of 5 milli moles (lower limit) to 400 milli moles (upper limit) per 100 g of the solid matter in the resin composition provided that the total content of the sulfonium and propargyl groups conditions to be mentioned later herein are satisfied. When this content is less than 5 milli moles per 100 g of the solid matter, curability cannot be adequately exerted, and hydratability and bath stability are deteriorated. When it exceeds 400 milli moles per 100 g of the solid matter, the film deposition on the surface of a substrate becomes poor. As for the sulfonium group content, a more preferable content can be selected in accordance with the resin skeleton employed. In the case of novolak phenol epoxy resins and novolak cresol epoxy resins, for example, the above lower limit is preferably 5 milli moles, more preferably 10 milli moles per 100 g of the solid matter in the resin composition. In addition, the above upper limit is preferably 250 milli moles, more preferably 150 milli moles per 100 g of the solid matter in the resin composition.

The propargyl group of the resin composition acts as a curable functional group in the cationic electrocoating.

Preferably, the propargyl group content in the resin composition is within a range of 10 milli moles (lower limit) to 495 milli moles (upper limit) per 100 g of the solid matter in the resin composition provided that the total content of the sulfonium and propargyl groups conditions to be mentioned later herein are satisfied. When this content is less than 10 milli moles per 100 g of the solid matter, curability cannot be sufficiently exerted, and when it exceeds 495 milli moles per 100 g of the solid matter, the hydration stability in the case of being used as an electrocoating may be affected. As for the propargyl group content, a more preferable content can be selected in accordance with the resin skeleton employed. In the case of novolak phenol epoxy resins and novolak cresol epoxy resins, for example, the above lower limit is more preferably 20 milli moles and the above upper limit is more preferably 395 milli moles, per 100 g of the solid matter in the resin composition.

The total content of the sulfonium and propargyl groups, in the above resin composition, is preferably 500 milli moles or less per 100 g of the solid matter in the resin composition. When this content exceeds 500 milli moles per 100 g of the solid matter, a resin may not be attained in fact or a desired performance may not be attained. As for the total content of the sulfonium and propargyl groups, in the above resin composition, a more preferable content can be selected in accordance with the resin skeleton employed. In the case of novolak phenol epoxy resins and novolak cresol epoxy resins, for example, the total content is more preferably 400 milli moles or less per 100 g of the solid matter in the resin composition.

Part of the propargyl group in the resin composition may be converted to an acetylide. An acetylide is a salt-like acetylated metal compound. As for the content of the propargyl group to be converted to an acetylide in the resin composition, preferably, the lower limit is 0.1 milli mole and the upper limit is 40 milli moles, per 100 g of the solid matter in the resin composition. When this content is less than 0.1 milli mole per 100 g of the solid matter, the effect of the conversion to an acetylide are not sufficiently exerted, and when it exceeds 40 milli moles, per 100 g of the solid matter, the conversion to an acetylide is difficult. As for this content, a more preferable range can be selected in accordance with the metal species employed.

A metal contained in the propargyl group converted to an acetylide is not particularly limited as long as it presents a catalytic action, and example thereof may include transition metals such as copper, silver and barium. If considering the conformity with an environment, copper and silver are preferable, and copper is more preferable from the viewpoint of the availability. When copper is used as the above-mentioned metal, the content of the propargyl group to be converted to an acetylide in the above resin composition is more preferably 0.1 to 20 milli moles per 100 g of the solid matter in the resin composition.

By converting part of the propargyl group in the above resin composition to an acetylide, a curing catalyst can be introduced into the resin. When the resin composition is prepared in this manner, it is unnecessary to use an organic transition metal complex which is generally difficult to dissolve or disperse in organic solvents and water and is possible to introduce even a transition metal easily through conversion to an acetylide, and therefore even a hard-to-dissolve transition metal compound is applicable to a coating composition without restraint. Further, the occurrence of an organic acid salt as an anion in the electrocoating bath, which is encountered when a transition metal organic acid salt is used, can be avoided and, furthermore, the metal ion will not be removed through ultrafiltration, hence the bath management and the design of electrocoatings become easy.

The resin composition may contain a carbon-carbon double bond where desired. Since the above-mentioned carbon-carbon double bond has high reactivity, curability can be further enhanced.

Preferably, the content of the above-mentioned carbon-carbon double bond is within a range of 10 milli moles (lower limit) to 485 milli moles (upper limit), per 100 g of the solid matter in the resin composition provided that the total content of the propargyl group and carbon-carbon double bond conditions to be mentioned later are satisfied. When this content is less than 10 milli moles per 100 g of the solid matter, an improvement in curability by addition of the carbon-carbon double bond cannot be adequately exerted, and when it exceeds 485 milli moles per 100 g of the solid matter, the hydration stability in the case of being used as an electrocoating may be affected. As for the content of the carbon-carbon double bond, a more preferable content can be selected in accordance with the resin skeleton employed. In the case of novolak phenol epoxy resins and novolak cresol epoxy resins, for example, the lower limit is preferably 20 milli moles and the upper limit is preferably 375 milli moles, per 100 g of the solid matter in the resin composition.

When the resin composition contains the above carbon-carbon double bond, the total content of the above propargyl group and the above carbon-carbon double bond is preferably within a range of 80 milli moles (lower limit) to 450 milli moles (upper limit), per 100 g of the solid matter in the above resin composition. When this content is less than 80 milli moles per 100 g of the solid matter, curability may become insufficient, and when it exceeds 450 milli moles per 100 g of the solid matter, the sulfonium group content becomes less and a dielectric breakdown voltage may become insufficient. As for the total content of the propargyl group and the carbon-carbon double bond, a more preferable content can be selected in accordance with the resin skeleton employed. In the case of novolak phenol epoxy resins and novolak cresol epoxy resins, for example, the lower limit is more preferably 10 milli moles and the upper limit is more preferably 395 milli moles, per 100 g of the solid matter in the resin composition.

In addition, when the resin composition contains the above carbon-carbon double bond, the total content of the sulfonium group, the propargyl group and the carbon-carbon double bond is preferably 500 milli moles or less per 100 g of the solid matter in the resin composition. When this content exceeds 500 milli moles per 100 g of the solid matter, a resin may not be attained in fact or a desired performance may not be attained. As for the total content of the sulfonium group, the propargyl group and the carbon-carbon double bond, a more preferable content can be selected in accordance with the resin skeleton employed. In the case of novolak phenol epoxy resins and novolak cresol epoxy resins, for example, the total content is more preferably 400 milli moles or less per 100 g of the solid matter in the resin composition.

The above resin composition can favorably be produced, for example, by the step (i) of reacting an epoxy resin having at least two epoxy groups in a molecule with a compound having a functional group capable of reacting with the epoxy group and a propargyl group to obtain an epoxy resin composition containing a propargyl group and the step (ii) of reacting the residual epoxy groups in the epoxy resin composition having a propargyl group(s) obtained in the step (i) with a sulfide/acid mixture to introduce the sulfonium group.

The above-mentioned compound having a functional group capable of reacting with the epoxy group and a propargyl group (hereinafter, referred to as “compound (A)”) maybe, for example, a compound having both a functional group capable of reacting with the epoxy group, such as a hydroxyl or carboxyl group, and a propargyl group. As specific examples, there may be given propargyl alcohol and propargylic acid. In particular, propargyl alcohol is preferable from the viewpoint of its availability and good reactivity.

For providing the above resin composition with a carbon-carbon double bond as required, a compound having a functional group capable of reacting with the epoxy group and a carbon-carbon double bond (hereinafter, referred to as “compound (B)”) may be used in combination with the compound (A) in the step (i). As the compound (B), a compound having both a functional group capable of reacting with the epoxy group, such as a hydroxyl or carboxyl group, and a carbon-carbon double bond may be used. Specifically, when the group capable of reacting with the epoxy group is a hydroxyl group, examples of the compound (B) may include 2-hydroxyethyl acrylate, 2-hydroxyethyl methacrylate, hydroxypropyl acrylate, hydroxypropyl methacrylate, hydroxybutyl acrylate, hydroxybutyl methacrylate, allyl alcohol, methacrylic alcohol, and the like. When the group capable of reacting with the epoxy group is a carboxyl group, examples of the compound (B) may include acrylic acid, methacrylic acid, ethacrylic acid, crotonic acid, maleic acid, phthalic acid, itaconic acid; half esters such as maleic acid ethyl ester, fumaric acid ethyl ester, itaconic acid ethyl ester, succinic acid mono (meth)acryloyloxyethyl ester, and phthalic acid mono (meth)acryloyloxyethyl ester; synthetic unsaturated fatty acids such as oleic acid, linolic acid, ricinolic acid, and the like; and nature-derived unsaturated fatty acids such as linseed oil, soybean oil, and the like.

In the step (i), the epoxy resin having at least two epoxy groups in a molecule is reacted with the compound (A) to obtain an epoxy resin composition containing a propargyl group(s) or reacted with the compound (A) and the compound (B) as required to obtain an epoxy resin composition containing a propargyl group(s) and carbon-carbon double bond. In the latter case, in the step (i), the compound (A) and compound (B) may be mixed together in advance and then subjected to reaction, or the compound (A) and compound (B) may be separately subjected to reaction. In addition, the functional group reacting with the epoxy group which the compound (A) has and the functional group reacting with the epoxy group which the compound (B) has may be the same or different.

When, in the step (i), the compound (A) and compound (B) are subjected to reaction with the epoxy resin, the portion between both compounds to be blended may be selected so as to attain the desired content of specified functional groups, for example, the above-mentioned contents of the propargyl group and carbon-carbon double bond.

As for the reaction conditions in the step (i), the reaction is generally carried out at room temperature or 80 to 140° C. for several hours. In addition, publicly known ingredients, which are required for the progress of the reaction, such as a catalyst and/or solvent may be used as required. The completion of the reaction can be checked by measuring an epoxy equivalent, and the functional group introduced can be identified by analysis of nonvolatile content and instrumental analysis of the resin composition obtained. The reaction product thus obtained generally occurs as a mixture of epoxy resins having one or more propargyl groups, or a mixture of epoxy resins having one or more propargyl groups and one or more carbon-carbon double bonds. In this sense, there can be obtained the resin composition having a propargyl group(s), or a propargyl group and carbon-carbon double bond through the step (i).

In the step (ii), the residual epoxy groups in the epoxy resin composition containing a propargyl group, obtained in the step (i), are reacted with a sulfide/acid mixture to introduce a sulfonium group. This introduction of the sulfonium group can be effected by the method which comprises causing the sulfide/acid mixture to react with the epoxy group to conduct introduction of the sulfide and conversion thereof to the sulfonium group or the method which comprises introducing a sulfide and then converting the introduced sulfide to a sulfonium group with an acid, an alkyl halide such as methyl fluoride, methyl chloride or methyl bromide, or the like, if necessary, followed by anion exchange. From the viewpoint of the availability of the reactant, the method using a sulfide/acid mixture is preferred.

The sulfide and acid are not particularly limited, and specifically, the above-mentioned substances can be given.

The mixing ratio between the sulfide and acid in the above sulfide/acid mixture is generally and preferably about 100/40 to 100/100 as expressed in terms of sulfide/acid mole ratio.

The reaction in the step (ii) can be carried out, for example, by mixing the epoxy resin composition having a propargyl group, obtained in the step (i), and the above sulfide/acid mixture in an amount selected so as to give the above-mentioned sulfonium group content, for instance, with water in an amount of 5 to 10 moles per mole of the sulfide used and stirring the mixture generally at 50 to 90° C. for several hours. A residual acid value of 5 or less may serve as a criterion in determining the reaction to be completed. The introduction of sulfonium group in the resin composition obtained can be identified by potentiometric titration.

The same procedure can be used also in the case where the sulfide is first introduced and then converted to the sulfonium group. By introducing the sulfonium group after introduction of the propargyl group, as described above, the sulfonium group can be prevented from being decomposed due to heating.

In the case of converting part of the propargyl group in the above resin composition to an acetylide, the conversion to the acetylide can be carried out by the step of reacting the epoxy resin composition, containing a propargyl group, obtained in the step (i) with a metal compound to thereby convert part of the propargyl group in the above epoxy resin composition to the corresponding acetylide. The above-mentioned metal compound is preferably a transition metal compound capable of giving an acetylide, and examples thereof may include complexes or salts of such transition metals as copper, silver and barium. Specific examples thereof may include acetylacetonato-copper, copper acetate, acetylacetonato-silver, silver acetate, silver nitrate, acetylacetonato-barium, and barium acetate. In particular, copper or silver compounds are preferable from the viewpoint of the conformity with an environment, and copper compounds are more preferable because of their ready availability. For example, acetylacetonato-copper is suitably used in view of the ease of bath control.

As for the reaction conditions of converting part of the propargyl group to an acetylide, the reaction is generally carried out at 40 to 70° C. for several hours. The progress of the reaction can be checked by the coloration of the resulting resin composition and/or the disappearance of the methine proton signal on a nuclear magnetic resonance spectrum. Thus, the time when the propargyl group-derived acetylide in the resin composition arrives at a desired level is determined and, at that time, the reaction is terminated. The reaction product obtained is generally a mixture of epoxy resins with one or more propargyl groups converted to an acetylide. A sulfonium group can be introduced, by the step (ii), into the thus obtained epoxy resin composition with part of the propargyl group converted to an acetylide.

The step of converting part of the propargyl group in the epoxy resin composition to an acetylide and the step (ii) can be carried out under common reaction conditions, so that both steps can be carried out simultaneously. The method of carrying out both steps simultaneously can advantageously simplify the production process.

In this way, the resin composition containing a propargyl group and a sulfonium group, and optionally containing a carbon-carbon double bond and/or a propargyl group-derived acetylide as required can be produced while preventing the sulfonium group from being decomposed. Incidentally, acetylides in a dry state are explosive but the reaction is carried out in an aqueous medium and the desired substance can be obtained in the form of an aqueous composition. Therefore, there arises no safety problem.

Since the cationic electrocoating comprises the resin composition and the resin composition itself is curable, it is not always necessary to use a curing agent. However, for further improving the curability, a curing agent maybe used. Examples of the curing agent may include compounds having a plurality of at least one species of propargyl groups and carbon-carbon double bonds, for example compounds obtained by adding a compound containing a propargyl group, such as propargyl alcohol, or a compound, containing carbon-carbon double bond, such as acrylic acid to polyepoxide such as a novolak phenol or pentaerythritol tetraglycidyl ether.

It is not always necessary to use a curing catalyst in the cationic electrocoating. However, when a further improvement in curability is required depending on the curing reaction conditions, a transition metal compound in general use may be appropriately added as required. Such compound is not particularly limited, and examples thereof may include complexes or compounds formed by combining a ligand, such as cyclopentadiene or acetylacetone, or a carboxylic acid such as acetic acid, with transition metals such as nickel, cobalt, manganese, palladium and rhodium. The amount of the above curing catalyst to be added is preferably from 0.1 milli mole (lower limit) to 20 milli moles (upper limit) per 100 g of the resin solid matter in the cationic electrocoating.

An amine may further be blended in the cationic electrocoating. By the addition of the amine, the conversion of the sulfonium group to a sulfide by electrolytic reduction in the process of electrodeposition is increased. The amine is not particularly limited, and examples thereof may include amine compounds such as primary to tertiary monofunctional or polyfunctional aliphatic amines, alicyclic amines and aromatic amines. In particular, water-soluble or water-dispersible ones are preferable. Examples of the amines may include alkylamines having 2 to 8 carbon atoms such as monomethylamine, dimethylamine, trimethylamine, triethylamine, propylamine, diisopropylamine and tributylamine; monoethanolamine, dimethanolamine, methylethanolamine, dimethylethanolamine, cyclohexylamine, morpholine, N-methylmorpholine, pyridine, pyrazine, piperidine, imidazoline, imidazole and the like. These may be used alone or two or more of them may be used in combination. In particular, hydroxy amines such as monoethanolamine, diethanolamine and dimethylethanolamine are preferred from the view point of excellent dispersion stability in water.

The above amine can be directly blended in the cationic electrocoating. While in the conventional neutralized amine type electrocoating, the addition of a free amine results in deprivation of the neutralizing acid in the resin, hence in marked deterioration of the stability of the electrocoating solution, no such bath stability trouble will arise in the present invention.

The amount of the above amine to be added is preferably 0.3 meq (lower limit) to 25 meq (upper limit) per 100 g of the resin solid matter in the cationic electrocoating. When this amount is less than 0.3 meq per 100 g, the film thickness retention may become insufficient. When it exceeds 25 meq per 100 g, the effects proportional to the addition amount can no longer be obtained; this is not economical. The lower limit is more preferably 1 meq per 100 g, and the upper limit is more preferably 15 meq per 100 g.

In the cationic electrocoating, there may also be incorporated an aliphatic hydrocarbon group-containing resin composition. The incorporation of the aliphatic hydrocarbon group-containing resin composition results in an improvement in the shock resistance of the coating films obtained. As the aliphatic hydrocarbon group-containing resin composition, there may be mentioned those containing, per 100 g of the solid matter in the resin composition, 5 to 400 milli moles of a sulfonium group, 80 to 135 milli moles of an aliphatic hydrocarbon group containing 8 to 24 carbon atoms and optionally containing an unsaturated double bond in the chain thereof and 10 to 315 milli moles of at least one of a propargyl group and organic groups containing 3 to 7 carbon atoms and having a terminal unsaturated double bond on condition that the total content of the sulfonium group, the aliphatic hydrocarbon group containing 8 to 24 carbon atoms and optionally containing an unsaturated double bond in the chain thereof and the propargyl group and organic groups containing 3 to 7 carbon atoms and having a terminal unsaturated double bond is not more than 500 milli moles per 100 g of the solid matter in the resin composition.

When such an aliphatic hydrocarbon group-containing resin composition is incorporated in the above cationic electrocoating, the resin solid matter in the cationic electrocoating preferably contains, per 100 g thereof, 5 to 400 milli moles of sulfonium group, 10 to 300 milli moles of the aliphatic hydrocarbon group containing 8 to 24 carbon atoms and optionally containing an unsaturated double bond in the chain thereof and a total of 10 to 485 milli moles of the propargyl group and organic groups containing 3 to 7 carbon atoms and having a terminal unsaturated double bond, and the total content of the sulfonium group, the aliphatic hydrocarbon group containing 8 to 24 carbon atoms and optionally containing an unsaturated double bond in the chain thereof, the propargyl group and the organic groups containing 3 to 7 carbon atoms and having a terminal unsaturated double bond is not more than 500 milli moles per 100 g of the resin solid matter in the cationic electrocoating, and the content of the aliphatic hydrocarbon group containing 8 to 24 carbon atoms and optionally containing an unsaturated double bond in the chain thereof is 3 to 30% by weight relative to the resin solid matter in the electrocoating.

When the aliphatic hydrocarbon group-containing resin composition is incorporated in the above cationic electrocoating and the sulfonium group content level is lower than 5 milli moles per 100 g, any satisfactory curability cannot be attained and, further, the hydratability and bath stability will be poor. When it exceeds 400 milli moles per 100 g, the deposition of films on the surface of the substrate becomes poor. When the content of the aliphatic hydrocarbon group containing 8 to 24 carbon atoms and optionally containing an unsaturated double bond in the chain thereof is less than 80 milli moles per 100 g, the shock resistance will not be improved to a satisfactory extent and, when it exceeds 350 milli moles per 100 g, the resin composition becomes difficult to handle. When the total content of the propargyl group and the organic groups containing 3 to 7 carbon atoms and having a terminal unsaturated double bond is less than 10 milli moles per 100 g, no satisfactory curability can be manifested on the occasion of combined use of another resin and per or another curing agent and, when it exceeds 315 milli moles per 100 g, the shock resistance will not be improved to a satisfactory extent. The total content of the sulfonium group, the aliphatic hydrocarbon group containing 8 to 24 carbon atoms and optionally having an unsaturated double bond in the chain thereof, the propargyl group and the organic groups containing 3 to 7 carbon atoms and having a terminal unsaturated double bond is not more than 500 milli moles per 100 g of the solid matter in the resin composition. When it exceeds 500 milli moles, any corresponding resin cannot be obtained in actuality or the desired performance characteristics cannot be obtained in some instances.

The above-mentioned cationic electrocoating may further contain another components used in an ordinary cationic electrocoating as required. The above-mentioned another component is not particularly limited, and examples thereof may include a pigment, a rust preventive, a pigment dispersion resin, a surfactant, an antioxidant and an ultraviolet absorber. However, when the above-mentioned components are used, it is preferred to adjust the amount of the component to be blended paying attention to the retention of a dielectric breakdown voltage.

The pigment is not particularly limited, and examples thereof may include coloring pigments such as titanium dioxide, carbon black and red iron oxide; rust-preventive pigments such as basic lead silicate and aluminum phosphomolybdate; and extender pigments such as kaoline, clay and talc. Examples of the rust preventive, specifically, may include calcium phosphite, zinc calcium phosphite, calcium-carrying silica, calcium-carrying zeolite, and the like. The total amount of the above-mentioned pigments and rust preventives to be added is preferably 0% by weight (lower limit) to 50% by weight (upper limit) in terms of the solid matter in the cationic electrocoating.

The pigment dispersion resins are used to stably disperse the pigments in the cationic electrocoating. The pigment dispersion resins are not particularly restricted but include those pigment dispersion resins which are in general use. A pigment dispersion resin containing a sulfonium group and an unsaturated bond within the resin may also be used. Such pigment dispersion resin containing a sulfonium group and an unsaturated bond can be obtained, for example, by the method comprising reacting a sulfide compound with a hydrophobic epoxy resin obtained by reacting a bisphenol-based epoxy resin with a half-blocked isocyanate, or reacting the resin with a sulfide compound in the presence of a monobasic acid and a hydroxyl group-containing dibasic acid. The pigment dispersion resins can also stably disperse the rust preventives containing no heavy metal in the cationic electrocoating.

The cationic electrocoating can be prepared, for example, by admixing the resin composition with the above-mentioned other ingredients as required and dissolving or dispersing the resulting composition in water. On the occasion of use in the electrodeposition step, the bath solution/dispersion prepared preferably has a nonvolatile matter content of 5% by weight (lower limit) to 40% by weight (upper limit). The preparation is preferably carried out in such a way that the contents of the propargyl group, carbon-carbon double bond and sulfonium group in the electrocoating may not deviate from the respective ranges indicated above referring to the resin composition.

In the method of coating an electric wire having edges of the present invention, the electrodeposition can be carried out using an electrodeposition apparatus in which the conventional cationic electrodeposition can be carried out. For example, the electrodeposition can be carried out using a cationic electrodeposition apparatus for electric wire which comprises an electrodeposition means, a washing means, and a heating means combined in that order. In this way, insulated wires having the high dielectric breakdown voltage can be obtained in an efficient manner. The electrodeposition apparatus that can be used may be a horizontal-electrodeposition apparatus in which electrodeposition is carried out while an electric wire being an article to be coated is pulled horizontally, or a vertical electrodeposition apparatus in which an electric wire being an article to be coated are introduced into the electrocoating bath from the bottom thereof and pulled out from the top of the electrocoating bath.

The above-mentioned electrodeposition means is aimed to form a film on the surface of an electric wire being a article to be coated by cationic electrodeposition using a cationic electrocoating. The electrodeposition means is not particularly limited as long as it is one capable of conducting cationic electrodeposition.

In operating the electrodeposition means, the method comprising, for example, immersing an article to be coated in the cationic electrocoating for utilizing the article as a cathode, and applying a voltage generally within the range of 50 to 450 V between the cathode and an anode may be given as an example. When the voltage applied is lower than 50 V, the dielectric breakdown voltage may be possibly lowered and insufficient electrodeposition will result. When it exceeds 450 V, the electricity consumption uneconomically increases. When the cationic electrocoating is used and a voltage within the range is applied, a uniform film can be formed on the whole material surface without any rapid increase in film thickness in the process of electrodeposition. In ordinary cases, a bath temperature of the cationic electrocoating in applying the above voltage is preferably 10 to 45° C.

The above-mentioned washing means is intended for washing the article with the cationic electrocoating adhering thereto to remove the electrocoating bath liquid. The washing means is not particularly restricted but may be any the conventional washing apparatus. For example, there may be given an apparatus in which the electrodeposited article is washed using, as a washing liquid, the filtrate obtained by ultrafiltration of the electrocoating bath liquid. As the above-mentioned heating means, there may be specifically given a hot air drying oven, a near-infrared heating oven, a far-infrared heating oven, and an induction heating oven, for instance.

The article to be coated, to which the method of coating an electric wire having edges in accordance with the present invention is applicable, is not particularly limited as long as it is one which exhibits conductivity by which cationic electrodeposition can be conducted and has edges, and examples thereof may include electric wires consisting of metals such as iron, copper, aluminum, gold, silver, nickel, tin, zinc, titanium and tungsten, and alloys containing these metals. In particular, an electric wire consisting of copper, gold, aluminum, iron or an alloy based on these metals is preferable.

The above-mentioned method of coating an electric wire having edges is favorably applicable to coating of an article to be coated having edges and can also be favorably applied particularly to coating of an electric wire having a small curvature of the edges in the cross-sectional profile, which is considered to be difficult to coating. In addition, the curvature used in this description refers to one, which is represented by (a radius of a curve of the edge/a length of a shorter side of two sides containing the edge)×100 with respect to the edge and two sides containing the edge in a cross section of the electric wire. When the method of coating an electric wire having edges in accordance with the present invention is applied to an article to be coated, having a curvature of the edges of 1 to 20%, an insulated wire, according to the metal foil method of JIS C3003 and having a dielectric breakdown voltage of 2 kV or higher, can be attained.

The insulated wire obtained by the above-mentioned method of coating an electric wire having edges is one in which a sufficient insulating film is formed throughout the whole surface of the article to be coated, that is, the whole surface including the edges and the dielectric breakdown voltage is further enhanced. Therefore, the insulated wire obtained by this coating method can be favorably used as an electric wire having a high dielectric breakdown voltage. Such the insulated wire, too, constitutes an aspect of the present invention.

The present invention is the method of coating an electric wire having edges, comprising the step of forming an insulating film by cationic electrodeposition using a cationic electrocoating, wherein the above-mentioned cationic electrocoating contains a resin composition of which a hydratable functional group is reduced directly by an electron and passivated, resulting in deposition of a film and the above-mentioned cationic electrocoating contains crosslinked resin particles. That is, in accordance with the above-mentioned method of coating an electric wire having edges, the insulating film can be formed in a sufficient film thickness even at edges of the article to be coated because the above-mentioned cationic electrocoating contains the above-mentioned crosslinked resin particles.

Accordingly, it is possible to attain insulated wires having a high dielectric breakdown voltage by adopting the method of coating an electric wire having edges of the present invention. And, particularly when the above-mentioned resin composition has a sulfonium group and a propargyl group, insulated wires having a higher dielectric breakdown voltage can be attained.

### EXAMPLES

Hereinafter, the present invention will be described more specifically by way of examples, but the present invention is not limited to these examples. In the examples, “part(s)” means “part(s) by weight”, unless otherwise specified.

### Production Example 1

Production of an Acrylic Resin 1 Having an Epoxy Group

Butyl cellosolve (120 parts) was put in a reaction container and heated under stirring at 120° C. A mixed solution of 2 parts of tert-butylperoxy-2-ethylhexanoate and 10 parts of butyl cellosolve, and a monomer mixture consisting of 40 parts of glycidylmethacrylate, 150 parts of 2-ethylhexyl methacrylate, 50 parts of 2-hydroxyethyl methacrylate and 65 parts of n-butyl methacrylate were added dropwise thereto over 3 hours. This mixture was aged for 30 minutes and, then, a mixed solution of 0.5 part of tert-butylperoxy-2-ethylhexanoate and 5 parts of butyl cellosolve was added dropwise thereto over 30 minutes. Further, the resulting mixture was aged for 2 hours to obtain the solution of an acrylic resin 1 having an epoxy group with a non-volatile content of 42%. The number-average molecular weight, measured by gel permeation chromatography (GPC) in terms of polystyrene, of this acrylic resin 1 having an epoxy group was 11000.

### Production Example 2

Production of an Ammonium Quaternizing Agent 1

Isophorone diisocyanate (220 parts), 40 parts of methyl isobutyl ketone and 0.22 part of dibutyltin dilaurate were put in a reaction container, and 135 parts of 2-ethylhexanol was added dropwise thereto at 55° C. Thereafter, the mixture was reacted at 60° C. for 1 hour to obtain a half-blocked isocyanate solution. This solution was further heated to 80° C. and a mixed solution of 90 parts of N,N-dimethylaminoethanol and 10 parts of methyl isobutyl ketone was added dropwise thereto over 30 minutes. After recognizing that an isocyanate group disappeared using infrared spectrum analysis, the mixed solution was cooled to room temperature to obtain tertiary amine having a blocked isocyanate group. This solution was neutralized by adding 180 parts of a 50% aqueous solution of lactic acid to obtain a solution of an ammonium quaternizing agent 1.

### Production Example 3

Production of an Ammonium Quaternizing Agent 2

A solution of an ammonium quaternizing agent 2 was obtained by following the same procedure as in Production Example 2 except for using 160 parts of triethylene glycol monomethyl ether in place of 135 parts of 2-ethylhexanol used as a block agent and changing the amount of methyl isobutyl ketone as a solvent from 40 parts to 25 parts.

### Production Example 4

Production of an Acrylic Resin 1 Having an Ammonium Group

120 parts of butyl cellosolve was put in a reaction container and heated under stirring at 120° C. A mixed solution of 2 parts of tert-butylperoxy-2-ethylhexanoate and 10 parts of butyl cellosolve, and a monomer mixture, consisting of 15 parts of glycidyl methacrylate, 50 parts of 2-ethylhexyl methacrylate, 40 parts of 2-hydroxyethyl methacrylate and 15 parts of n-butyl methacrylate were added thereto in a dropwise manner over 3 hours. This mixture was aged for 30 minutes and, then, a mixed solution of 0.5 part of tert-butylperoxy-2-ethylhexanoate and 5 parts of butyl cellosolve was added thereto in a dropwise manner over 30 minutes. The resulting mixture was further aged for 2 hours and cooled. This acrylic resin 2 having an epoxy group had the number-average molecular weight of 12,000 and the weight-average molecular weight of 28000, measured by GPC. By adding 7 parts of N,N-dimethylaminoethanol and 15 parts of a 50% aqueous solution of lactic acid to this acrylic resin 2 and heating under stirring at 80° C., the acrylic resin 2 was quaternized. Heating was stopped at the time when an acid value reached 1 or less and a viscosity rise stopped to obtain the solution of an acrylic resin 1 having an ammonium group with a nonvolatile content of 30%. The number of ammonium groups per one molecule of this acrylic resin 1 having an ammonium group was 6.0.

### Production Example 5

Production of an Acrylic Resin 2 Having an Ammonium Group

By adding 100 parts of the solution of the ammonium quaternizing agent 1 produced in Production Example 2 to 240 parts of the acrylic resin 1 having an epoxy group produced in Production Example 1 and heating under stirring at 80° C., the mixture was quaternized. Heating was stopped at the point in time when an acid value reached 1 or less and a viscosity rise was not recognized to obtain the solution of an acrylic resin 2 having an ammonium group with a non-volatile content of 39%. The number of ammonium groups per a molecule of this acrylic resin 2 having an ammonium group was 8.5.

### Production Example 6

Production of an Acrylic Resin 3 Having an Ammonium Group

The solution of an acrylic resin 3 having an ammonium group with a non-volatile content of 36% was obtained by following the same procedure as in Production Example 5 except for using 80 parts of the solution of the ammonium quaternizing agent 2 produced in Production Example 3 in place of 100 parts of the solution of the ammonium quaternizing agent 1. The number of ammonium groups per a molecule of this acrylic resin 3 having an ammonium group was 4.0.

### Production Example 7

Production of a Crosslinked Resin Particle 1

In a reaction container, 20 parts of the acrylic resin 1 having an ammonium group, produced in Production Examples 4, and 270 parts of ion-exchanged water were put, and the mixture was heated under stirring at 75° C. An aqueous solution of 1.5 parts of 2,2′-azobis(2-(2-imidazoline-2-yl)propane) neutralized wholly with acetic acid was added dropwise thereto over 5 minutes. The mixed solution was aged for 5 minutes and, then, 30 parts of methyl methacrylate was added dropwise thereto over 5 minutes. The mixture was further aged for 5 minutes, and preemulsion, which was obtained by adding an α,β-ethylenically unsaturated monomer mixture consisting of 170 parts of methyl methacrylate, 40 parts of styrene, 30 parts of n-butyl methacrylate, 5 parts of glycidyl methacrylate and 30 parts of neopentyl glycol dimethacrylate to a mixed solution of 70 parts of the acrylic resin 1 having an ammonium group and 250 parts of ion-exchanged water under stirring, was added dropwise thereto over 40 minutes. This mixture was aged for 60 minutes and, then, cooled to obtain a dispersion of a crosslinked resin particle 1. The resulting dispersion of the crosslinked resin particle 1 had a non-volatile content of 35%, a pH of 5.0 and a volume-average particle diameter of 100 nm.

### Production Example 8

Production of a Crosslinked Resin Particle 2

In a reaction container, 20 parts of the acrylic resin 2 having an ammonium group, produced in Production Examples 5, and 300 parts of ion-exchanged water were put, and the mixture was heated under stirring at 75° C. An aqueous solution of 1 part of 2,2′-azobis(2-(2-imidazoline-2-yl)propane) neutralized wholly with acetic acid was added dropwise thereto over 5 minutes. The mixed solution was aged for 5 minutes and, then, 25 parts of methyl methacrylate was added dropwise thereto over 5 minutes. The mixture was further aged for 5 minutes and, then, preemulsion, which was obtained by adding an α,β-ethylenically unsaturated monomer mixture consisting of 140 parts of methyl methacrylate, 30 parts of styrene, 25 parts of n-butyl methacrylate, 5 parts of glycidyl methacrylate and 25 parts of neopentyl glycol dimethacrylate to a mixed solution of 55 parts of the acrylic resin 2 having an ammonium group and 270 parts of ion-exchanged water under stirring, was added dropwise thereto over 40 minutes. This mixture was aged for 60 minutes and, then, cooled to obtain a dispersion of a crosslinked resin particle 2. The resulting dispersion of the crosslinked resin particle 2 had a non-volatile content of 30%, a pH of 5.5 and a volume-average particle diameter of 100 nm.

### Production Example 9

Production of a Crosslinked Resin Particle 3

A dispersion of a crosslinked resin particle 3 was obtained by following the same procedure as in Production Example 8 except that in place of the acrylic resin 2 having an ammonium group used as an emulsifier, the same amount of the acrylic resin 3 having an ammonium group was used. The resulting dispersion of the crosslinked resin particle 3 had a non-volatile content of 30%, a pH of 5.5 and a volume-average particle diameter of 90 nm.

### Production Example 10

Production of a Crosslinked Resin Particle 4

An aqueous dispersion of a crosslinked resin particle 4 was obtained by following the same procedure as in Production Example 8 except for changing the amount of neopentyl glycol dimethacrylate in the α,β-ethylenically unsaturated monomer mixture from 25 parts to 40 parts. The resulting aqueous dispersion of the crosslinked resin particle 4 had a non-volatile content of 30%, a pH of 5.0 and a volume-average particle diameter of 150 nm.

### Production Example 11

Production of a Crosslinked Resin Particle 5 Using an Emulsifier Other than an Acrylic Resin Having an Ammonium Group

Hexadecyltrimethylammonium chloride (7 parts) was put in a reaction container as an emulsifier and dissolved in 300 parts of ion-exchanged water, and the dissolved solution was heated under stirring at 75° C. An aqueous solution of 1 part of 2,2′-azobis(2-(2-imidazoline-2-yl)propane) neutralized wholly with acetic acid was added dropwise thereto over 5 minutes. The mixed solution was aged for 5 minutes and, then, 10 parts of methyl methacrylate was added dropwise thereto over 5 minutes. The mixture was further aged for 5 minutes, and preemulsion, which was obtained by adding an α,β-ethylenically unsaturated monomer mixture consisting of 140 parts of methyl methacrylate, 30 parts of styrene, 25 parts of n-butyl methacrylate, 5 parts of glycidyl methacrylate and 25 parts of neopentyl glycol dimethacrylate to a mixed solution of 22 parts of hexadecyltrimethylammonium chloride and 270 parts of ion-exchanged water under stirring, was added dropwise thereto over 40 minutes. This mixture was aged for 60 minutes and, then, cooled to obtain a dispersion of a crosslinked resin particle 5, which had a non-volatile content of 30%, a pH of 5.2 and a volume-average particle diameter of 120 nm.

### Production Example 12

Production of a Non-Crosslinked Resin Particle

In a reaction container, 20 parts of the acrylic resin 1 having an ammonium group, produced in Production Examples 4, and 300 parts of ion-exchanged water were put, and the mixture was heated under stirring at 75° C. An aqueous solution of 1 part of 2,2′-azobis(2-(2-imidazoline-2-yl)propane) neutralized wholly with acetic acid was added dropwise thereto over 5 minutes. The mixed solution was aged for 5 minutes and, then, 10 parts of methyl methacrylate was added dropwise thereto over 5 minutes. The mixture was further aged for 5 minutes, and preemulsion, which was obtained by adding an α,β-ethylenically unsaturated monomer mixture containing no poly(meth)acrylate, consisting of 140 parts of methyl methacrylate, 30 parts of styrene, 25 parts of n-butyl methacrylate and 5 parts of glycidyl methacrylate, to an aqueous solution of 55 parts of the acrylic resin 1 having an ammonium group and 270 parts of ion-exchanged water under stirring, was added dropwise thereto over 40 minutes. This mixture was aged for 60 minutes and, then, cooled to obtain a dispersion of a non-crosslinked resin particle. The resulting dispersion of the non-crosslinked resin particle had a non-volatile content of 32.8%, a pH of 5.0 and a volume-average particle diameter of 106 nm.

### Production Example 13

Production of an Epoxy Resin Composition Having a Sulfonium Group and a Propargyl Group

In a separable flask provided with a stirrer, a thermometer, a nitrogen gas inlet tube and a reflux cooling tube, 100.0 parts of EPOTOHTO YDCN-701 with an epoxy equivalent of 200.4 (cresol novolak type epoxy resin made by Tohto Kasei Co., Ltd.), 23.6 parts of propargyl alcohol and 0.3 part of dimethylbenzylamine were put, and the mixture was heated to 105° C. and reacted at that temperature for 3 hours to obtain a resin composition containing a propargyl group with an epoxy equivalent of 1580. Acetylacetonate-copper (2.5 parts) was added thereto, and the reaction was allowed to proceed at 50° C. for 1.5 hours. It was verified that part of the terminal hydrogens of the added propargyl groups was disappeared by proton (1H) NMR (propargyl converted to acetylide equivalent to 14 milli moles per 100 g of the resin solid matter).

1-(2-hydroxyethylthio)-2,3-propanediol (10.6 parts), 4.7 parts of glacial acetic acid and 7.0 parts of deionized water were added thereto, and the reaction was allowed to proceed for 6 hours while maintaining the temperature at 75° C. After verification that the residual acid value is 5 or less, 43.8 parts of deionized water was added to give an intended resin composition solution. This solution had a solid matter content of 70.0% by weight and the sulfonium value of 28.0 milli moles per 100 g varnish. The number-average molecular weight (determined by GPC on the polystyrene equivalent basis) was 2,443.

### Production Example 14

Production of a Cationic Electrocoating

To 142.9 parts of the resin composition obtained in Production Example 13 was added 157.1 parts of deionized water, and the mixture was stirred in a high-speed rotary mixer for 1 hour and, then, this aqueous solution was adjusted so as to have a solid matter content of 15% by weight to obtain a cationic electrocoating.

### Production Example 15

Production of a Cationic Electrocoating

The resin composition obtained in Production Example 13 (142.9 parts) and 157.1 parts of deionized water were mixed and, to this mixture, the dispersion of the crosslinked resin particle 1 obtained in Production Example 7 was further added in such a manner that the solid matter content of the dispersion is 20% by weight relative to the resin solid matter in the coating. After the mixture was stirred in a high-speed rotary mixer for 1 hour, 373.3 parts of deionized water was added and, then, this aqueous solution was adjusted so as to have a solid matter content of 15% by weight to obtain a cationic electrocoating.

### Production Examples 16 to 19

Production of a Cationic Electrocoating

Cationic electrocoatings were obtained by following the same procedure as in Production Example 15 except for using the dispersion of crosslinked resin particles 2 to 5 obtained in Production Examples 8 to 11 in place of the dispersion of the crosslinked resin particle 1 obtained in Production Example 7.

### Production Example 20

Production of a Cationic Electrocoating

A cationic electrocoating was obtained by following the same procedure as in Production Example 15 except for using the dispersion of the non-crosslinked resin particle obtained in Production Example 12 in place of the dispersion of the crosslinked resin particle 1 obtained in Production Example 7.

### Production Example 21

Production of a Crosslinked Resin Particle 6

Into a separable flask provided with a dropping funnel, a thermometer, a nitrogen gas inlet tube, a reflux cooling tube and a stirrer were charged 289.6 parts of ion-exchanged water and 10.3 parts of a resin dilution solution prepared by diluting the epoxy resin composition produced in Production Example 13 until the solid matter content of the epoxy resin composition reaches 36.1%. The temperature of this mixture was raised to 70° C. under being stirred in a nitrogen atmosphere. An aqueous solution consisting of 20.0 parts of ion-exchanged water, 0.5 part of VA-061 (azo initiator produced by Wako Pure Chemical Industries, Ltd.) and 0.3 part of an 90% aqueous solution of acetic acid was added thereto dropwise over 5 minutes. To this mixture, a preemulsion, which was prepared by adding a monomer mixture consisting of 80 parts of styrene and 20 parts of divinylbenzene to an emulsifier solution formed by dissolving 20.5 parts of a resin dilution solution identical to the above one in 130 parts of ion-exchanged water and by emulsifying the resulting mixture with a mixer, was added dropwise from a dropping funnel constantly over 75 minutes. After the completion of the dropwise addition, the preemulsion mixture was aged at that temperature for 60 minutes and then cooled. With the addition of ion-exchanged water, a dispersion of a crosslinked resin particle 6, having a nonvolatile content of 20%, was obtained. The resulting dispersion of the crosslinked resin particle 6 had a pH of 4.8 and a volume-average particle diameter of 100 nm.

### Production Examples 22

Production of a Cationic Electrocoating

A cationic electrocoating was obtained by following the same procedure as in Production Example 15 except for using the dispersion of the crosslinked resin particle 6 obtained in Production Example 21 in place of the dispersion of the crosslinked resin particle 1 obtained in Production Example 7 and preparing a coating in such a manner that a solid matter content was equivalent to that in Production Example 15.

### Production Example 23

Production of a Crosslinked Resin Particle 7

Into a separable flask provided with a dropping funnel, a thermometer, a nitrogen gas inlet tube, a reflux cooling tube and a stirrer were charged 289.0 parts of ion-exchanged water and 10.0 parts of AQUARON HS-10 (α-sulfo-ω-[2-(1-propenyl)-4-nonyl-phenoxy]polyoxyethylene (n=10) ammonium salt, made by Daiichi Kogyo Seiyaku Co., Ltd.), and the temperature of this mixture was raised to 80° C. in a nitrogen atmosphere. Aside from this mixture, a preemulsion was prepared by adding a monomer mixture solution consisting of 13 parts of styrene, 42 parts of methyl methacrylate and 45 parts of ethylene glycol dimethacrylate to an emulsifier solution formed by dissolving 5.0 parts of AQUARON HS-10 in 134.5 parts of ion-exchanged water and by emulsifying the resulting mixture with a mixer. To the mixture described above, the preemulsion thus prepared and an initiator solution formed by dissolving 0.5 part of ammonium persulfate in 36.7 parts of ion-exchanged water were added dropwise simultaneously from two separate dropping funnels. The preemulsion was added constantly over 60 minutes and the initiator solution constantly over 75 minutes. After the completion of the dropwise addition, the resulting mixture was aged at that temperature for 60 minutes and then cooled. With the addition of ion-exchanged water, a dispersion of a crosslinked resin particle 7, having a nonvolatile content of 15%, was obtained. The resulting dispersion of the crosslinked resin particle 7 had a pH of 7.3 and a volume-average particle diameter of 80 nm.

### Production Example 24

Production of a Cationic Electrocoating

A cationic electrocoating was obtained by following the same procedure as in Production Example 15 except for using the dispersion of a crosslinked resin particle 7 obtained in Production Example 23 in place of the dispersion of a crosslinked resin particle 1 obtained in Production Example 7 and preparing a coating in such a manner that a solid content was equivalent to that in Production Example 15.

### Examples 1 to 6

Insulating films were formed on the surface of a rectangular copper wire using the insulating coating compositions obtained in Production Examples 15 to 19 and 22, respectively, by subjecting the rectangular wire having edges (a cross section profile being rectangular and having a size of 0.5mm×0.1 mm, and the curvature being 10%) to the following pretreatment means, electrodeposition means, washing means and heating means.

[Pretreatment Means]

(1) The electric wire was degreased with SURF POWER (made by NIPPON PAINT Co., Ltd.) at a treatment temperature of 45° C. for a treatment time of 60 seconds.

(2) The degreased electric wire was washed with water by spraying for 30 seconds.

[Electrodeposition Means]

The wire after water washing was immersed in the cationic electrocoating obtained in Production Examples 15 to 19 and 22 stored as an electrocoating bath liquid in an electrocoating bath and cationic electrodeposited at a bath temperature of 30° C. for 5 seconds with a voltage of 100 V being applied (with the wire as the cathode and the counter electrode as the anode).

[Washing Means]

The wire obtained after each immersion period of cationic electrodeposition was washed with water by spraying for 30 seconds to remove the cationic electrocoating adhering to the wire.

[Heating Means]

Each wire after washing was heated in a hot air drying oven at 190° C. for 25 minutes to form an insulating film and give an insulated wire.

### Comparative Example 1

An insulated wire was obtained by following the same procedure as in Example 1 except for using the cationic electrocoating obtained in Production Example 14 in place of the cationic electrocoating obtained in Production Example 15.

### Comparative Example 2

An insulated wire was obtained by following the same procedure as in Example 1 except for using the cationic electrocoating obtained in Production Example 20 in place of the cationic electrocoating obtained in Production Example 15.

### Example 7

An insulated wire was obtained by following the same procedure as in Example 1 except for using the cationic electrocoating obtained in Production Example 24 in place of the cationic electrocoating obtained in Production Example 15.

[Evaluation]

The insulated wires obtained in Examples 1 to 7 and Comparative Examples 1 and 2 were evaluated on a dielectric breakdown voltage using a withstand voltage insulation tester (Model 8525 manufactured by Tsuruga Electric Co.) by the metal foil method according to JIS C 3003. The results are shown in Table 1.

TABLE 1

| | Dielectric breakdown |
|---|---|
| | voltage (kV) |
| Example 1 | 2.6 |
| Example 2 | 2.8 |
| Example 3 | 2.6 |
| Example 4 | 2.4 |
| Example 5 | 2.7 |
| Example 6 | 3.1 |
| Example 7 | 1.2 |
| Comparative | 0.5 |
| example 1 | |
| Comparative | 0.7 |
| example 2 | |

It is shown from Table 1 that the insulated wires obtained in the examples had higher dielectric breakdown voltage than those obtained in the comparative examples.

### INDUSTRIAL APPLICABILITY

The method of coating an electric wire having edges of the present invention has the above-mentioned constitution, so that it can attain an insulated wire having a high dielectric breakdown voltage. In addition, since the insulated wire becomes higher in a occupancy ratio, it can improve its performances compared with the case of using a round wire and can be favorably used as, for example, a magnet wire. Therefore, the insulated wire, obtained by the method of coating an electric wire having edges of the present invention, can be favorably used in various applications as one having the high dielectric breakdown voltage.

1. A method of coating an electric wire having edges, comprising a step of:
forming an insulating film by cationic electrodeposition using a cationic electrocoating,
the cationic electrocoating containing a resin composition of which a hydratable functional group is reduced directly by electrons and passivated, resulting in deposition of a film, and
the cationic electrocoating containing crosslinked resin particles.

2. The method of coating an electric wire having edges according to claim 1,
wherein the crosslinked resin particle being one of which a hydratable functional group is reduced directly by electrons and passivated.

3. The method of coating an electric wire having edges according to claim 1 or 2,
wherein the content of the crosslinked resin particles is 0.5 to 40% by weight.

4. The method of coating an electric wire having edges according to claim 1 or 2,
wherein the crosslinked resin particle is obtained by emulsion polymerizing an α,β-ethylenically unsaturated monomer mixture using a resin having an onium group as an emulsifier.

5. The method of coating an electric wire having edges according to claim 4,
wherein the resin having an onium group has 2 to 15 onium groups per one molecule.

6. The method of coating an electric wire having edges according to claim 4,
wherein the resin having an onium group is an acrylic resin or an epoxy resin.

7. The method of coating an electric wire having edges according to claim 4,
wherein the onium group is an ammonium group or a sulfonium group.

8. The method of coating an electric wire having edges according to claim 7,
wherein the acrylic resin or the epoxy resin, having the ammonium group or the sulfonium group, is obtained by adding a tertiary amine compound or sulfide and an organic acid to an acrylic resin or an epoxy resin, having an epoxy group, to convert the acrylic resin or the epoxy resin to a quaternary ammonium compound or a tertiary sulfonium compound.

9. The method of coating an electric wire having edges according to claim 8,
wherein a number-average molecular weight of the acrylic resin or the epoxy resin, having an epoxy group, is 2000 to 20000.

10. The method of coating an electric wire having edges according to claim 1 or 2,
wherein the resin composition has a sulfonium group and a propargyl group.

11. The method of coating an electric wire having edges according to claim 1 or 2,
wherein the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

12. The method of coating an electric wire having edges according to claim 1 or 2,
wherein the resin composition includes an epoxy resin having a novolak cresol epoxy resin or a novolak phenol epoxy resin as a skeleton and having a number-average molecular weight of 700 to 5000, and
the resin composition also has a sulfonium group content of 5 to 250 milli moles, a propargyl group content of 20 to 395 milli moles and a total content of the sulfonium and propargyl groups of 400 milli moles or less, per 100 g of the solid matter in the resin composition.

13. An insulated wire obtained by the method of coating an electric wire having edges according to claim 1 or 2.
